(19) United States
(12) Patent Application Publication
(10) Pub. No.: US 2010/0330354 A1
(43) Pub. Date: Dec. 30, 2010

(54) PRESSURE-SENSITIVE ADHESIVE TAPE

(76) Inventors: Tatsuya Tsukagoshi, Osaka (JP); Yutaka Tosaki, Osaka (JP); Junji Yokoyama, Osaka (JP); Yoshikazu Soeda, Osaka (JP); Noboru Yoshida, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 12/821,486

(22) Filed: Jun. 23, 2010

(30) Foreign Application Priority Data
Jun. 26, 2009 (JP) 2009-152631

(51) Int. Cl. C09J 7/02; B32B 27/30; C08F 2/44

(52) U.S. Cl. 428/220; 428/355 AC; 524/853

(57) ABSTRACT

The present invention provides a pressure-sensitive adhesive tape capable of exhibiting excellent adhesive property, and of inhibiting deformation of an adherend fixed with this pressure-sensitive adhesive tape, even under a high temperature or low temperature environment. The pressure-sensitive adhesive tape is one having a pressure-sensitive adhesive layer including a pressure-sensitive adhesive composition containing a (meth)acrylic polymer, wherein the (meth)acrylic polymer is obtained by copolymerization of a monomer mixture containing, at least, 60 to 96% by weight of a (meth)acrylic acid alkyl ester having an alkyl group with 4 to 12 carbon atoms, 2 to 10% by weight of a carboxyl group-containing monomer, and 2 to 8% by weight of an ethylenically unsaturated monomer having no carboxyl group, whose homopolymer has a glass transition temperature of 50 to 190° C. as monomer components, and the pressure-sensitive adhesive layer has a gel fraction of 0 to 30% by weight.

### TECHNICAL FIELD

The present invention relates to a pressure-sensitive adhesive tape having a pressure-sensitive adhesive layer using a (meth)acrylic polymer obtained by copolymerization of specific monomers.

### BACKGROUND ART

Double-sided pressure-sensitive adhesive tapes can be stamped and processed into any shape before they are bonded to articles, and they are utilized for fixing articles in various industrial fields because of their good workability. In particular, because displays or face plates of portable electronic instruments such as PDAs (Personal Digital Assistance) and cell phones have small and complicated shapes, the double-sided pressure-sensitive adhesive tapes are often used for fixing these small parts.

Recently, portable electronic instruments are required more and more to be thinner due to their manner of utilization, and parts used inside the instruments also have been made thinner. For example, brightness enhancement films and reflector sheets, which are used inside portable electronic instruments, are more likely to have this tendency. These brightness enhancement films and the like are fixed through double-sided pressure-sensitive adhesive sheets or the like.

The portable electronic instruments, which have been made thinner and thinner, cause a problem such as poor impact resistance because of the thinness. In order to solve the problem, Patent Document 1 and Patent Document 2 disclose a method of controlling a loss tangent of a pressure-sensitive adhesive layer forming a double-sided pressure-sensitive adhesive sheet in a specific temperature range; and a method of controlling a loss tangent or a storage modulus of a pressure-sensitive adhesive layer at a specific temperature, whereby pressure-sensitive adhesive sheets having high impact resistance are obtained.

Also, a problem occurs in which adherends such as touch panels bend at high temperature or under high-temperature and high humidity, because transparent plastic substrates used in the touch panels are made thinner. In order to solve this problem, Patent Document 3 attempts to prevent the bending by laminating a transparent plastic substrate on a double-sided pressure-sensitive adhesive sheet having a pressure-sensitive adhesive layer using an acrylic polymer and an oligomer, whose weight average molecular weights are within specific ranges.

Patent Document 1: JP-A-2005-187513

Patent Document 2: JP-A-2008-231358

Patent Document 3: JP-A-2005-255877

### DISCLOSURE OF THE INVENTION

### Problems to be Solved by the Invention

According to the patent documents listed above, the double-sided pressure-sensitive adhesive sheets have improved impact resistance when a portable electronic instrument is dropped, and improved transparency; however, a problem occurs in which the adherends such as brightness enhancement films, which are fixed on the double-sided pressure-sensitive adhesive sheets, deform when they are exposed to environmental change, such as in a high temperature or low temperature environment.

An object of the present invention is to provide a pressure-sensitive adhesive tape capable of exhibiting excellent adhesive property, and of inhibiting deformation of an adherend fixed with the pressure-sensitive adhesive tape even under a high temperature or low temperature environment.

### Means for Solving the Problems

As a result of painstaking studies for solving the problems described above, the present inventors have found that when a pressure-sensitive adhesive tape has a pressure-sensitive adhesive layer including a pressure-sensitive adhesive composition containing, as an essential component, a (meth)acrylic polymer obtained by copolymerization of a specific monomer mixture, and the pressure-sensitive adhesive layer has a gel fraction with a specific range, then the pressure-sensitive adhesive tape exhibits high adhesive property under environmental change, such as in a high temperature or low temperature environment, and the tape can inhibit an adherend fixed therewith from deformation; and they have completed the present invention. They also have found that when a pressure-sensitive adhesive tape has a pressure-sensitive adhesive layer including a pressure-sensitive adhesive composition containing, as an essential component, a (meth)acrylic polymer obtained by copolymerization of at least specific monomers, and a storage modulus, a loss modulus and a tan δ of the pressure-sensitive adhesive layer at a specific temperature are controlled to specific ranges, then the problems described above can be solved; and they have completed the present invention. They further have found that when a pressure-sensitive adhesive tape has a pressure-sensitive adhesive layer including a pressure-sensitive adhesive composition containing, as an essential component, a (meth)acrylic polymer obtained by copolymerization of at least specific monomers, and a maximum stress and a maximum elongation in a stress-strain curve of the pressure-sensitive adhesive layer at a specific temperature are controlled to specific ranges, then the problems described above can be solved; and they have completed the present invention.

That is, the pressure-sensitive adhesive tape of the present invention is a pressure-sensitive adhesive tape having a pressure-sensitive adhesive layer including a pressure-sensitive adhesive composition containing a (meth)acrylic polymer, wherein the (meth)acrylic polymer is obtained by copolymerization of a monomer mixture containing, at least, 60 to 96% by weight of a (meth)acrylic acid alkyl ester having an alkyl group with 4 to 12 carbon atoms, and further containing 2 to 10% by weight of a carboxyl group-containing monomer and 2 to 8% by weight of an ethylenically unsaturated monomer having no carboxyl group, whose homopolymer has a glass transition temperature of 50 to 190° C., as monomer components, and the pressure-sensitive adhesive layer has a gel fraction of 0 to 30% by weight. The pressure-sensitive adhesive tape of the present invention may be either a pressure-sensitive adhesive tape having a substrate and a pressure-sensitive adhesive layer, or a monolayer pressure-sensitive adhesive tape (double-sided pressure-sensitive adhesive tape) having a pressure-sensitive adhesive layer alone. Preferably, in the pressure-sensitive adhesive tape of the present invention, the pressure-sensitive adhesive layer has a maximum stress of 0.8 to 1.6 N/mm² and a maximum elongation of 1000 to 1700% in the stress-strain curve at 0° C.

The pressure-sensitive adhesive tape of the present invention is a pressure-sensitive adhesive tape having a pressure-sensitive adhesive layer including a pressure-sensitive adhesive composition containing a (meth)acrylic polymer obtained by polymerizing at least a (meth)acrylic acid alkyl ester having an alkyl group with 4 to 12 carbon atoms, wherein the pressure-sensitive adhesive layer has a storage modulus of 8.0×10⁵ to 1.5×10⁷ Pa at −30° C., a loss modulus of 9.7×10⁵ to 1.7×10⁷ Pa at −30° C., and a tan δ of 0.50 to 0.63 at 80° C. Also, the pressure-sensitive adhesive tape of the present invention is one wherein the (meth)acrylic polymer is obtained by copolymerization of a monomer mixture containing, at least, 60 to 96% by weight of a (meth)acrylic acid alkyl ester having an alkyl group with 4 to 12 carbon atoms, and further containing 2 to 10% by weight of a carboxyl group-containing monomer and 2 to 8% by weight of an ethylenically unsaturated monomer having no carboxyl group, whose homopolymer has a glass transition temperature of 50 to 190° C. as monomer components, and the pressure-sensitive adhesive layer has a gel fraction of 0 to 30% by weight.

Preferably, the ethylenically unsaturated monomer in the pressure-sensitive adhesive tape of the present invention is cyclohexyl methacrylate.

Further, the pressure-sensitive adhesive tape of the present invention is a pressure-sensitive adhesive tape having a pressure-sensitive adhesive layer including a pressure-sensitive adhesive composition containing a (meth)acrylic polymer obtained by polymerizing at least a (meth)acrylic acid alkyl ester having an alkyl group with 4 to 12 carbon atoms, wherein the pressure-sensitive adhesive layer has a maximum stress of 0.8 to 1.6 N/mm² and a maximum elongation of 1000 to 1700% in the stress-strain curve at 0° C.

The pressure-sensitive adhesive tape of the present invention preferably has the pressure-sensitive adhesive layer formed on at least one side of the substrate. The pressure-sensitive adhesive tape of the present invention may include generally called “double-sided pressure-sensitive adhesive tape,” which have the pressure-sensitive adhesive layers on the both sides of the substrate, not on one side, and also may be a pressure-sensitive adhesive tape having a pressure-sensitive adhesive layer alone and no substrate (without a substrate), depending on the use.

The pressure-sensitive adhesive layer in the pressure-sensitive adhesive tape of the present invention has preferably a thickness of 2 to 20 μm.

The pressure-sensitive adhesive tape of the present invention is preferably used for fixing parts of a portable electronic instrument. The term “portable electronic instrument” herein refers to a portable electronic instrument such as a cell phone or a PDA. Also, the tape can be used in, for example, liquid crystal displays, plasma displays and organic EL displays used in digital cameras, video cameras, car navigation systems, personal computers, televisions and game machines, in addition to the portable electronic instruments described above.

### EFFECT OF THE INVENTION

The pressure-sensitive adhesive tape of the present invention exhibits excellent effects in which adhesive property to an adherend fixed with this pressure-sensitive adhesive tape is excellent even under environmental change, such as in a high temperature or low temperature environment, and the deformation of the adherend can be inhibited. It is especially useful for bonding (fixing) members having a small and complicated shape (for example, brightness enhancement films, reflector sheets or polarizing plates), such as display parts or face plates of portable electronic instruments such as PDAs and cell phones. Further, when the tape is used as a double-sided pressure-sensitive adhesive tape, it can be advantageously used for fixing parts whose adherend surface is subjected to a hard-coating treatment on plastic parts. Furthermore, even if a member such as a brightness enhancement film laminated on the tape is exposed to environmental change, such as in a high temperature or low temperature environment, the deformation of the brightness enhancement film can be usefully inhibited.

### DETAILED DESCRIPTION OF THE PREFERRED EMBODIMENTS

The present invention will be described in detail in accordance with preferable embodiments.

The pressure-sensitive adhesive tape of the present invention is a pressure-sensitive adhesive tape having a pressure-sensitive adhesive layer including a pressure-sensitive adhesive composition containing a (meth)acrylic polymer, wherein the (meth)acrylic polymer is obtained by copolymerization of a monomer mixture containing, at least, 60 to 96% by weight of a (meth)acrylic acid alkyl ester having an alkyl group with 4 to 12 carbon atoms, 2 to 10% by weight of a carboxyl group-containing monomer, and 2 to 8% by weight of an ethylenically unsaturated monomer having no carboxyl group, whose homopolymer has a glass transition temperature of 50 to 190° C., and the pressure-sensitive adhesive layer has a gel fraction of 0 to 30% by weight.

Also, the pressure-sensitive adhesive tape of the present invention is a pressure-sensitive adhesive tape having a pressure-sensitive adhesive layer including a pressure-sensitive adhesive composition containing a (meth)acrylic polymer obtained by polymerizing at least a (meth)acrylic acid alkyl ester having an alkyl group with 4 to 12 carbon atoms, wherein the pressure-sensitive adhesive layer has a storage modulus of 8.0×10⁵ to 1.5×10⁷ Pa at −30° C., a loss modulus of 9.7×10⁵ to 1.7×10⁷ Pa at −30° C., and a tan δ of 0.50 to 0.63 at 80° C.

Further, the pressure-sensitive adhesive tape of the present invention is a pressure-sensitive adhesive tape having a pressure-sensitive adhesive layer including a pressure-sensitive adhesive composition containing a (meth)acrylic polymer obtained by polymerizing at least a (meth)acrylic acid alkyl ester having an alkyl group with 4 to 12 carbon atoms, wherein the pressure-sensitive adhesive layer has a maximum stress of 0.8 to 1.6 N/mm² and a maximum elongation of 1000 to 1700% in the stress-strain curve at 0° C.

Components for constituting the (meth)acrylic polymer used in the present invention are specifically explained below. The (meth)acrylic acid alkyl ester having an alkyl group with 4 to 12 carbon atoms, which is a main monomer, includes, for example, n-butyl (meth)acrylate, isobutyl (meth)acrylate, sec-butyl (meth)acrylate, t-butyl (meth)acrylate, pentyl (meth)acrylate, isopentyl (meth)acrylate, neopentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, isodecyl (meth)acrylate, undecyl (meth)acrylate, and dodecyl (meth)acrylate. These alkyl groups may be either linear or branched. As the (meth)acrylic acid alkyl ester, (meth)acrylic acid alkyl esters having an alkyl group with 4 to 9 carbon atoms are preferable, and n-butyl acrylate, 2-ethylhexyl acrylate, isooctyl acrylate, and isononyl acrylate are more preferable. These (meth)acrylic acid alkyl esters may be used alone or as a mixture of the two or more kinds thereof.

The content of the main monomer, the (meth)acrylic acid alkyl ester is from 60 to 96% by weight, preferably from 87 to 95% by weight, and more preferably from 90 to 94% by weight, based on the whole monomer components constituting the (meth)acrylic polymer. When the content is controlled within the range described above, the desired peeling force and cohesive force, which are required for pressure-sensitive adhesive tapes, can be preferably obtained.

The carboxyl group-containing monomer includes, for example, (meth)acrylic acid, itaconic acid, crotonic acid, maleic acid, fumaric acid, isocrotonic acid, ω-carboxy-polycaprolactone mono(meth)acrylates (for example, ω-carboxy-polycaprolactone (the average number of repetition, n=2) mono(meth)acrylate, ω-carboxy-polycaprolactone (the average number of repetition, n=3) mono(meth)acrylate, ω-carboxy-polycaprolactone (the average number of repetition, n=4) mono(meth)acrylate, etc.); phthalic acid monohydroxyalkyl (meth)acrylates (for example, phthalic acid monohydroxymethyl (meth)acrylate, phthalic acid monohydroxyethyl (meth)acrylate, phthalic acid monohydroxypropyl (meth)acrylate, phthalic acid monohydroxybutyl (meth)acrylate, phthalic acid monohydroxypentyl (meth)acrylate, phthalic acid monohydroxyhexyl (meth)acrylate, phthalic acid monohydroxyheptyl (meth)acrylate, phthalic acid monohydroxyoctyl (meth)acrylate, phthalic acid monohydroxy-2-ethylhexyl (meth)acrylate, phthalic acid monohydroxynonyl (meth)acrylate, phthalic acid monohydroxydecyl (meth)acrylate, phthalic acid monohydroxyundecyl (meth)acrylate, phthalic acid monohydroxydodecyl (meth)acrylate, etc.); succinic acid monohydroxyalkyl (meth)acrylates (for example, succinic acid monohydroxymethyl (meth)acrylate, succinic acid monohydroxyethyl (meth)acrylate, succinic acid monohydroxypropyl (meth)acrylate, succinic acid monohydroxybutyl (meth)acrylate, succinic acid monohydroxypentyl (meth)acrylate, succinic acid monohydroxyhexyl (meth)acrylate, succinic acid monohydroxyheptyl (meth)acrylate, succinic acid monohydroxyoctyl (meth)acrylate, succinic acid monohydroxy-2-ethylhexyl (meth)acrylate, succinic acid monohydroxynonyl (meth)acrylate, succinic acid monohydroxydecyl (meth)acrylate, succinic acid monohydroxyundecyl (meth)acrylate, succinic acid monohydroxydodecyl (meth)acrylate, etc.); acrylic acid dimer; acrylic acid trimer; hexahydrophthalic acid monohydroxyalkyl (meth)acrylates (for example, hexahydrophthalic acid monohydroxymethyl (meth)acrylate, hexahydrophthalic acid monohydroxyethyl (meth)acrylate, hexahydrophthalic acid monohydroxypropyl (meth)acrylate, hexahydrophthalic acid monohydroxybutyl (meth)acrylate, hexahydrophthalic acid monohydroxypentyl (meth)acrylate, hexahydrophthalic acid monohydroxyhexyl (meth)acrylate, hexahydrophthalic acid monohydroxyheptyl (meth)acrylate, hexahydrophthalic acid monohydroxyoctyl (meth)acrylate, hexahydrophthalic acid monohydroxy-2-ethylhexyl(meth)acrylate, hexahydrophthalic acid monohydroxynonyl (meth)acrylate, hexahydrophthalic acid monohydroxydecyl (meth)acrylate, hexahydrophthalic acid monohydroxyundecyl (meth)acrylate, hexahydrophthalic acid monohydroxydodecyl (meth)acrylate, etc.), and the like. They may be used alone or as a mixture of the two or more kinds thereof. Among these, acrylic acid and methacrylic acid are preferable because the adhesive property, which is required for pressure-sensitive adhesive tapes, can be obtained therefrom.

In addition to the main monomer, the (meth)acrylic acid alkyl ester, the content of the carboxyl group-containing monomer is from 2 to 10% by weight, preferably from 2 to 6% by weight, and more preferably from 2 to 4% by weight, based on the whole monomer components constituting the (meth)acrylic polymer. When the content of the carboxyl group-containing monomer is less than 2% by weight, the carboxyl group-containing monomer cannot exhibit enough function for forming cross-linking points in the obtained (meth)acrylic polymer, and thus the desired cohesive force, which is required for pressure-sensitive adhesive tapes, cannot be undesirably obtained. On the other hand, when the content is more than 10% by weight, it is undesirably difficult to inhibit the deformation.

The ethylenically unsaturated monomers having no carboxyl group, whose homopolymer has a glass transition temperature of 50 to 190° C., are not particularly limited, and include, for example, methyl methacrylate, (meth)acryloyl morpholine, cyclohexyl methacrylate, n-vinyl pyrrolidone, isobornyl (meth)acrylate, cyclohexyl maleimide, isopropyl maleimide, (meth)acrylamide, and the like. Among these, cyclohexyl methacrylate is preferable.

The homopolymer formed from the ethylenically unsaturated monomer has a glass transition temperature (Tg) of 50 to 190° C., and preferably 60 to 190° C. When an ethylenically unsaturated monomer whose homopolymer has a Tg of less than 50° C. is used, the desired cohesive force, which is required for pressure-sensitive adhesive tapes, cannot be undesirably obtained, and the deformation cannot be undesirably inhibited. On the other hand, when the Tg is more than 190° C., the desired adhesive property, which is required for pressure-sensitive adhesive tapes, cannot be undesirably obtained.

In addition of the main monomer, the (meth)acrylic acid alkyl ester, the content of the ethylenically unsaturated monomer is from 2 to 8% by weight, preferably from 2 to 6% by weight, and more preferably from 2 to 4% by weight, based on the whole monomer components constituting the (meth)acrylic polymer. When the content of the ethylenically unsaturated monomer is outside the range described above, it is undesirably difficult to inhibit the deformation.

Here, the value of the “glass transition temperature” may be adopted from the value in a catalogue of a monomer manufacture. If there are no catalogue values, the value refers to one obtained by a measurement method described below. That is, to a reactor equipped with a thermometer, a stirrer, a tube for introducing nitrogen and a condenser are added 100 parts by weight of the ethylenically unsaturated monomer, 0.2 parts by weight of azobisisobutyronitrile and 220 parts by weight of ethyl acetate as a polymerization solvent, and the mixture is stirred for one hour while nitrogen gas is introduced thereto. After oxygen is removed from the polymerization system in this manner, the temperature of the system is elevated to 63° C., and the reaction is performed for 10 hours. Then, the temperature is cooled to room temperature to obtain a solution including a homopolymer obtained from the ethylenically unsaturated monomer in a solid concentration of 30% by weight. Then, the polymer solution is cast on a release liner, thereby applying the solution to the liner, and it is dried at 50° C. for 24 hours to produce a test sample (a homopolymer in the state of a sheet) having a thickness of about 2 mm. The test sample is stamped into a disk having a diameter of 7.9 mm, it is sandwiched between parallel plates, and a viscoelasticity is measured, using a viscoelasticity tester (ARES manufactured by Rheometrics Inc.) within a temperature range of −70° C. to 150° C. at a rate of temperature increase of 5° C./minute in a shear mode, while applying a shear strain of a frequency of 1 Hz. A peak-top temperature of a loss modulus G″ is defined as a glass transition temperature.

As a monomer component constituting the (meth)acrylic polymer, a monomer copolymerizable with the (meth)acrylic acid alkyl ester, the carboxyl group-containing monomer or the ethylenically unsaturated monomer may be used in combination, if necessary. The content of the copolymerizable monomer may be suitably selected depending on the kind of the monomer, so long as the content is less than 36% by weight based on the whole monomer components. In order to obtain good adhesive property, it is desirable to decide the content so that the obtained (meth)acrylic polymer has a glass transition temperature of −40° C. or less, preferably −50° C. or less, more preferably −60° C. or less.

In order to control the cohesive force of the (meth)acrylic polymer, examples of the copolymerizable monomer include vinyl ester monomers such as vinyl acetate and vinyl propionate; styrene monomers such as styrene, substituted styrene (α-methyl styrene, etc.), and vinyl toluene; olefin monomers such as ethylene, propylene, isoprene, butadiene, and isobutylene; vinyl chloride, vinylidene chloride; isocyanate group-containing monomers such as 2-(meth)acryloyloxyethyl isocyanate; alkoxy group-containing monomers such as methoxyethyl (meth)acrylate and ethoxyethyl (meth)acrylate; vinyl ether monomers such as methyl vinyl ether and ethyl vinyl ether; and polyfunctional monomers such as 1,6-hexanediol di(meth)acrylate, ethylene glycol di(meth)acrylate, diethylene glycol di(meth)acrylate, triethylene glycol di(meth)acrylate, tetraethylene glycol di(meth)acrylate, (poly)ethylene glycol di(meth)acrylate, propylene glycol di(meth)acrylate, (poly)propylene glycol di(meth)acrylate, neopentyl glycol di(meth)acrylate, pentaerythritol di(meth)acrylate, trimethylol propane tri(meth)acrylate, pentaerythritol tri(meth)acrylate, dipentaerythritol hexa(meth)acrylate, glycerin di(meth)acrylate, epoxyacrylate, polyester acrylate, urethane acrylate, divinyl benzene, butyl di(meth)acrylate, and hexyl di(meth)acrylate, and the like. They may be used alone or as a mixture of the two or more kinds thereof.

The polymerization method of the monomer (mixture) is not particularly limited, and, for example, a solution polymerization method, a suspension polymerization method, an emulsion polymerization method, or an UV polymerization method may be adopted. Among these, a solution polymerization method is preferable, because of the cost, and because it is not required to use water upon polymerization and therefore the invasion of water to a small article can be prevented when the article is bonded with the pressure-sensitive adhesive tape.

The initiator used in the polymerization reaction includes, for example, azo initiators such as 2,2′-azobisisobutyronitrile (AIBN), 2,2′-azobis(4-methoxy-2,4-dimethyl valeronitrile), 2,2′-azobis(2,4-dimethyl valeronitrile), 2,2′-azobis(2-methylbutylnitrile), 1,1′-azobis(cyclohexane-1-carbonitrile), 2,2′-azobis(2,4,4-trimethylpentane), dimethyl-2,2′-azobis(2-methyl propionate), 2,2′-azobis(2-amidinopropane) dihydrochloride, 2,2′-azobis(N,N′-dimethylene isobutyl amidine) dihydrochloride, 2,2′-azobis[2-(5-methyl-2-imidazolin-2-yl)propane]dihydrochloride, 2,2′-azobis(2-methylpropionamidine) disulfate; peroxides such as benzoyl peroxide, t-butyl hydroperoxide, di-t-butyl hydroperoxide, di-t-butyl peroxide, t-butyl peroxybenzoate, dicumyl peroxide, 1,1-bis(t-butyl peroxy)-3,3,5-trimethyl cyclohexane, and 1,1-bis(t-butyl peroxy)cyclododecane; persulfates such as potassium persulfate and ammonium persulfate, and the like. They may be used alone or as a mixture of the two or more kinds thereof. The initiator may be used in an amount that is usually used in the polymerization reaction described above, and the amount is, for example, from 0.01 to 1 part by weight based on 100 parts by weight of the monomer mixture.

Solvents generally used in a polymerization reaction may be used as the solvent used in the polymerization reaction described above, and include, for example, ethyl acetate, toluene, n-butyl acetate, n-hexane, cyclohexane, methyl ethyl ketone, methyl isobutyl ketone, and the like. They may be used alone or as a mixture of the two or more kinds thereof. The amount of the solvent used may be an amount usually used in the polymerization reaction described above, and it may be, for example from about 50 to 600 parts by weight based on 100 parts by weight of the monomer mixture.

The (meth)acrylic polymer used in the present invention has a weight average molecular weight of preferably 200,000 to 1,000,000, more preferably 400,000 to 800,000. When the molecular weight is within the range described above, the desired cohesive force and adhesive property, which are required for pressure-sensitive adhesive tapes, can be desirably obtained.

The weight average molecular weight of the (meth)acrylic polymer can be controlled through the kind and amount of the polymerization initiator and a chain transfer agent, the temperature and time of the polymerization, the monomer concentration, the dropping rate of the monomers, and the like.

In the present invention, the weight average molecular weight (Mw) of the (meth)acrylic polymer can be measured using a gel permeation chromatograph (GPC). More specifically, using “HLC-8120 GPC” (trade name) manufactured by Tosoh Corporation as a GPC measuring apparatus, it can be found by measurement under the following GPC measurement conditions in terms of polystyrene.

### (GPC Measurement Conditions)

Sample concentration: 0.2% by weight (in a tetrahydrofuran solution)
Amount of sample injected: 10 μl
Eluent: tetrahydrofuran (THF)
Flow volume (flow rate): 0.6 mL/minute
Column temperature (measured temperature): 40° C.
Column: trade name “TSKgelSuper HM-H/H 4000/H 3000/H 2000” manufactured by Tosoh Corporation
Detector: a differential refractive index detector

The method for controlling a gel fraction of the pressure-sensitive adhesive layer used in the present invention is not particularly limited, and for example a method in which a cross-linking agent is added to the (meth)acrylic polymer may be exemplified. The cross-linking agent is not particularly limited, and conventionally known ones may be used. Examples thereof include polyfunctional melamine compounds such as methylated methylol melamine and butylated hexamethylol melamine; polyfunctional epoxy compounds such as N,N′,N′-tetraglycidyl m-xylenediamine, diglycidyl aniline, and glycerin diglycidyl ether; polyfunctional isocyanate compounds such as tolylene diisocyanate, hexamethylene diisocyanate, polymethylene polyphenyl isocyanate, diphenylmethane diisocyanate, trimethylolpropane tolylene diisocyanate, polyether polyisocyanate, and polyester polyisocyanate, and the like. In addition, carbodiimide cross-linking agents, aziridine cross-linking agents, and metal chelate cross-linking agents may be also exemplified. They may be used alone or as a mixture of the two or more kinds thereof.

The amount of the cross-linking agent used is usually preferably from 0.001 to 20 parts by weight, more preferably from 0.001 to 10 parts by weight, particularly preferably from 0.01 to 5 parts by weight, based on 100 parts by weight of the (meth)acrylic polymer. When the amount is within the range described above, the desired cohesive force and adhesive property, which are required for pressure-sensitive adhesive tapes (pressure-sensitive adhesives) can be preferably obtained.

In the present invention, the gel fraction refers to a value calculated according to the following “Method for Measuring Gel Fraction”.

### (Method for Measuring Gel Fraction)

First, after the pressure-sensitive adhesive composition (solution) is applied to a release liner, which is dried or cured, and the pressure-sensitive adhesive layer is taken therefrom, or the pressure-sensitive adhesive layer is scraped from the pressure-sensitive adhesive tape. About 0.1 g of the pressure-sensitive adhesive layer is wrapped with a Teflon (registered trademark) sheet (trade name “NTF1122”, manufactured by Nitto Denko Corporation) having a diameter of 0.2 μm, and it is strapped with a kite yarn. The weight thereof is measured, which is defined as a weight before immersion. The weight before immersion is a total weight of the pressure-sensitive adhesive layer, the Teflon sheet, and the kite yarn. The weight of the Teflon sheet and the kite yarn is measured, which is defined as a wrapper weight. Next, the pressure-sensitive adhesive layer wrapped with the Teflon sheet and strapped with the kite yarn is put in a 50 ml-container filled with ethyl acetate, which is allowed to stand at room temperature for one week. After that, the Teflon sheet is taken out from the container, and it is dried in a dryer at 130° C. for two hours to remove ethyl acetate, and then the weight of the sample is measured, which is defined as a weight after immersion. The gel fraction is calculated from the following equation:

Gel fraction (% by weight)=(A−B)/(C−B)×100

wherein A is a weight after immersion, B is a wrapper weight, and C is a weight before immersion.

In the present invention, it is necessary that the gel fraction calculated from the method for measuring the gel fraction described above be from 0 to 30% by weight, preferably from 1 to 30% by weight. When the gel fraction is more than 30% by weight, it is difficult to obtain an adequate cohesive force, and the range is not preferable from the viewpoint of the deformation resistance.

Furthermore, in addition to the cross-linking agent, general additives such as an ultraviolet absorber, a light stabilizer, a peel-controlling agent, a tackifying resin, a chain transfer agent, a plasticizer, a softening agent, a filler, a coloring agent (a pigment, a dye, etc.), an antioxidant, and a surfactant may be added to the pressure-sensitive adhesive composition.

In the pressure-sensitive adhesive tape of the present invention, the pressure-sensitive adhesive layer has a maximum stress of 0.8 to 1.6 N/mm² and a maximum elongation of 1000 to 1700%, preferably has a maximum stress of 1.0 to 1.2 N/mm² and a maximum elongation of 1200 to 1500%, in the stress-strain curve at 0° C. The case in which the maximum stress is more than 1.6 N/mm² and/or the maximum elongation is less than 1000% is not preferable, because a deformation volume of the pressure-sensitive adhesive layer is too small, and thus when such a tape is used inside a portable electronic instrument, the tape easily peels from a member (for example, a brightness enhancement film, etc.) provided in the instrument. On the other hand, the case in which the maximum stress is less than 0.8 N/mm² and/or the maximum elongation is more than 1700% is not also preferable, because the pressure-sensitive adhesive layer has poor cohesive force, and disadvantages such as poor workability may possibly occur.

In the present invention, the maximum stress and the maximum elongation refer to values calculated according to a “Method for Measuring Stress-Strain” below.

### (Method for Measuring Stress-Strain)

A solution of the pressure-sensitive adhesive is cast to a release-treated side of a polyethylene terephthalate film (thickness: 38 μm), thereby applying the solution to the film so that a thickness is about 4 μm after drying, and it is heat-dried at 130° C. for 3 minutes, and then aged at 50° C. for 24 hours, from which a cylindrical sample having a cross-sectional area of 1 mm² is formed. This sample is set on a tension tester (SHIMADZU AUTOGRAPH model AG-IS MS manufactured by Shimadzu Corporation), and a maximum stress (N/mm²) and a maximum elongation (%), generated by pulling the sample at 0° C. under conditions of a distance between chucks of 10 mm and a tensile rate of 300 mm/minute, are measured. The maximum elongation (%) is calculated from a length of the sample before pulling and a length of the sample when the sample is broken by pulling, according to the following equation:

Maximum elongation (%)=100×(a length at break)/(a length of a sample before pulling)

Here, in the present invention, “deformation” refers to a height difference (waviness), which generates on the surface of an adherend (for example, a brightness enhancement film, a reflector sheet, a polarizing plate, etc.), when a pressure-sensitive adhesive tape is evaluated according to Evaluation Method of Deformation Resistance described below.

Also, in the pressure-sensitive adhesive tape of the present invention, the pressure-sensitive adhesive layer has a storage modulus of 8.0×10⁵ to 1.5×10⁷ Pa at −30° C., a loss modulus of 9.7×10⁵ to 1.7×10⁷ Pa at −30° C., and a tan δ of 0.50 to 0.63 at 80° C., preferably has a storage modulus of 1.8×10⁶ to 2.4×10⁶ Pa at −30° C., a loss modulus of 2.4×10⁶ to 3.1×10⁶ Pa at −30° C., and a tan δ of 0.50 to 0.60 at 80° C. The case in which the pressure-sensitive adhesive layer has either a storage modulus of more than 1.5×10⁷ Pa at −30° C., or a loss modulus of more than 1.7×10⁷ Pa at −30° C., or a tan δ of less than 0.50 at 80° C. is not preferable, because when such a tape is used inside a portable electronic instrument, the tape easily peels from a member (for example, a brightness enhancement film, etc.) provided in the instrument. On the other hand, the case in which the pressure-sensitive adhesive layer has either a storage modulus of less than 8.0×10⁵ Pa at −30° C., or a loss modulus of less than 9.7×10⁵ Pa at −30° C., or a tan δ of more than 0.63 at 80° C. is not also preferable, because when such a tape is used inside a portable electronic instrument, a member (for example, a brightness enhancement film, etc.) provided inside the instrument easily deforms, and the workability is poor.

### (Method for Measuring Viscoelasticity)

A solution of the pressure-sensitive adhesive is cast on a release-treated surface of a polyethylene terephthalate film (thickness: 38 μm) whose one side has been subjected to release treatment, thereby applying the solution to the film so that a thickness is about 50 μm after drying it, and it is heat-dried at 130° C. for 3 minutes, and then aged at 50° C. for 24 hours. The pressure-sensitive adhesive layer is peeled from the film. Then, a plurality of the pressure-sensitive adhesive layers are stacked to give a pressure-sensitive adhesive layer having a thickness of about 2 mm. The pressure-sensitive adhesive layer is stamped into a disk having a diameter of 7.9 mm, and the disk is sandwiched with parallel plates and fixed, and a loss modulus G″ and a storage modulus G′ thereof are measured using a viscoelasticity tester (ARES manufactured by Rheometrics Inc.). The measurement conditions are as follows:

Measurement: shear mode
Temperature range: −70° C. to 100° C.
Rate of temperature increase: 5° C./minute

### Frequency: 1 Hz

The pressure-sensitive adhesive tape (including pressure-sensitive adhesive sheet and pressure-sensitive adhesive film) of the present invention is useful for uses for fixing (bonding) in various fields. For example, they may be used in the form of a pressure-sensitive adhesive tape (double-sided pressure-sensitive adhesive tape) having a pressure-sensitive adhesive monolayer (without a substrate); a pressure-sensitive adhesive tape having a pressure-sensitive adhesive layer on one side of a substrate; a double-sided pressure-sensitive adhesive tape having pressure-sensitive adhesive layers on both sides of a substrate; or one in which a pressure-sensitive adhesive monolayer is formed on a peeling film.

Methods for forming the pressure-sensitive adhesive tape of the present invention are not particularly limited, and known methods may be employed. For example, a method in which a pressure-sensitive adhesive composition solution is applied to a substrate in a suitable spreading method such as a flow casting method or a coating method, and dried; a method in which a pressure-sensitive adhesive layer is transferred using a release sheet on which the layer is provided, and the like are exemplified. As the applying methods, roll coating methods such as reverse coating and gravure coating, spin coating methods, screen coating methods, fountain coating methods, dipping methods and spray methods can be employed. When the pressure-sensitive adhesive solution is applied and then the solvent is volatilized in a drying step, a pressure-sensitive adhesive layer having a predetermined thickness can be obtained.

The thickness of the pressure-sensitive adhesive layer is not particularly limited, and it is preferably from 2 to 20 μm, more preferably from 2 to 10 μm. When the thickness of the pressure-sensitive adhesive layer is thinner than 2 μm, it is difficult to obtain sufficient adhesion. On the other hand, when it is thicker than 20 μm, protruding of adhesive, stamping defect or the like easily occurs when such a tape is stamped into a desired shape for fixing a small article, and the workability tends to be poor.

Any substrate may be used without particular limitation, so long as it is generally used in the field of pressure-sensitive adhesive tapes, and examples thereof may include plastics (cellophane, polyethylene, polypropylene, polyester, polyvinyl chloride, acetate, polystyrene, polyacrylonitrile, polyethylene terephthalate, laminates thereof, etc.); rubber sheets; papers (Japanese paper, kraft paper, etc.); fabrics (cotton, staple fiber, chemical fiber, unwoven fabric, etc.); metal foil, and the like. Also, films or foams composed of a polymer having an elastic property may be used. In addition, substrates which have been subjected to a known treatment such as under-coating treatment, filling treatment, corona treatment or back face treatment may be used.

The thickness of the substrate is not particularly limited, and suitably selected depending on the kind of the substrate or the use. It is usually from about 5 to 500 μm.

### EXAMPLES

The present invention is described in more detail by means of Examples, but it is not limited thereto. In the following, part is “part by weight,” unless otherwise indicated.

### (Production of (Meth)Acrylic Polymer A)

To a reactor equipped with a thermometer, a stirrer, a tube for introducing nitrogen, and a condenser were added 92 parts of 2-ethylhexyl acrylate (2EHA), 4 parts of cyclohexyl methacrylate (CHMA), and 4 parts of acrylic acid (AA) as monomer components and 120 parts of ethyl acetate as a polymerization solvent, and the mixture was stirred for one hour, while nitrogen was introduced thereto, whereby the inside of the polymerization system was substituted with nitrogen. After that, the temperature of the system was elevated to 63° C., and then 0.2 parts of 2,2′-azobisisobutyronitrile (AIBN) dissolved in 2 parts of ethyl acetate was added, which was reacted at that temperature for 8 hours to obtain a (meth)acrylic polymer A having a weight average molecular weight of 570,000.

### (Production of (Meth)Acrylic Polymer B)

A (meth)acrylic polymer B having a weight average molecular weight of 580,000 was obtained in the same manner as in the production method of the (meth)acrylic polymer A, except that 92 parts of 2-ethylhexyl acrylate, 4 parts of methyl methacrylate (MMA), and 4 parts of acrylic acid were used as monomer components.

### (Production of (Meth)Acrylic Polymer C)

A (meth)acrylic polymer C having a weight average molecular weight of 660,000 was obtained in the same manner as in the production method of the (meth)acrylic polymer A, except that 86 parts of 2-ethylhexyl acrylate, 10 parts of cyclohexyl methacrylate, and 4 parts of acrylic acid were used as monomer components.

### (Production of (Meth)Acrylic Polymer D)

A (meth)acrylic polymer D having a weight average molecular weight of 610,000 was obtained in the same manner as in the production method of the (meth)acrylic polymer A, except that 84 parts of 2-ethylhexyl acrylate, 4 parts of cyclohexyl methacrylate, and 12 parts of acrylic acid were used as monomer components.

### (Production of (Meth)Acrylic Polymer E)

A (meth)acrylic polymer E having a weight average molecular weight of 660,000 was obtained in the same manner as in the production method of the (meth)acrylic polymer A, except that 96 parts of 2-ethylhexyl acrylate and 4 parts of acrylic acid were used as monomer components.

### (Production of (Meth)Acrylic Polymer F)

A (meth)acrylic polymer F having a weight average molecular weight of 550,000 was obtained in the same manner as in the production method of the (meth)acrylic polymer A, except that 88 parts of 2-ethylhexyl acrylate, 8 parts of cyclohexyl methacrylate, and 4 parts of acrylic acid were used as monomer components.

### Example 1

A pressure-sensitive adhesive composition solution was prepared by adding 0.015 parts of a tetrafunctional epoxy cross-linking agent (trade name: Tetrad C manufactured by Mitsubishi Gas Chemical Company, Inc.) and one part of an isocyanate cross-linking agent (trade name: Coronate L manufactured by Nippon Polyurethane Industry Co., Ltd.) to 100 parts (solid content) of the (meth)acrylic polymer A. The solution was coated on a polyethylene terephthalate film whose surface had been subjected to release treatment (release liner having a thickness of 38 μm) so that a thickness was 4 μm after drying, which was heat-dried at 130° C. for 3 minutes to form a pressure-sensitive adhesive layer. Two pieces of the layers were made, and both sides of a polyethylene terephthalate film (substrate having a thickness of 22 μm) were laminated therewith, which was aged at 50° C. for 24 hours to produce a double-sided pressure-sensitive adhesive tape having the pressure-sensitive adhesive layers on the both sides of the substrate. This pressure-sensitive adhesive layer had a gel fraction of 13%.

### Example 2

A double-sided pressure-sensitive adhesive tape was produced in the same manner as in Example 1, except that the tetrafunctional epoxy cross-linking agent (trade name: Tetrad C, manufactured by Mitsubishi Gas Chemical Company, Inc.) was used in an amount of 0.02 parts. This pressure-sensitive adhesive layer had a gel fraction of 25%.

### Example 3

A double-sided pressure-sensitive adhesive tape was produced in the same manner as in Example 2, except that the (meth)acrylic polymer B was used. This pressure-sensitive adhesive layer had a gel fraction of 23%.

### Example 4

A pressure-sensitive adhesive composition solution was prepared by adding 0.01 parts of a tetrafunctional epoxy cross-linking agent (trade name: Tetrad C, manufactured by Mitsubishi Gas Chemical Company, Inc.) to 100 parts (solid matter) of the (meth)acrylic polymer A. The solution was coated on a polyethylene terephthalate film whose surface had been subjected to release treatment (release liner having a thickness of 38 μm) so that a thickness was 4 μm after drying, which was heat-dried at 130° C. for 3 minutes to form a pressure-sensitive adhesive layer. Two pieces of the layers were made, and both sides of a polyethylene terephthalate film (substrate having a thickness of 22 μm) were laminated therewith, which was aged at 50° C. for 24 hours to produce a double-sided pressure-sensitive adhesive tape having the pressure-sensitive adhesive layers on the both sides of the substrate. This pressure-sensitive adhesive layer had a gel fraction of 7%.

### Example 5

A double-sided pressure-sensitive adhesive tape was produced in the same manner as in Example 4, except that one part of an isocyanate cross-linking agent (trade name: Coronate L, manufactured by Nippon Polyurethane Industry Co., Ltd.) was added, in addition to the tetrafunctional epoxy cross-linking agent (trade name: Tetrad C, manufactured by Mitsubishi Gas Chemical Company, Inc.). This pressure-sensitive adhesive layer had a gel fraction of 13%.

### Example 6

A double-sided pressure-sensitive adhesive tape was produced in the same manner as in Example 4, except that the tetrafunctional epoxy cross-linking agent was not added. This pressure-sensitive adhesive layer had a gel fraction of 0%.

### Comparative Example 1

A double-sided pressure-sensitive adhesive tape was produced in the same manner as in Example 2, except that the (meth)acrylic polymer C was used. This pressure-sensitive adhesive layer had a gel fraction of 28%.

### Comparative Example 2

A double-sided pressure-sensitive adhesive tape was produced in the same manner as in Example 2, except that the (meth)acrylic polymer D was used. This pressure-sensitive adhesive layer had a gel fraction of 56%.

### Comparative Example 3

A double-sided pressure-sensitive adhesive tape was produced in the same manner as in Example 2, except that the (meth)acrylic polymer E was used. This pressure-sensitive adhesive layer had a gel fraction of 18%.

### Comparative Example 4

A double-sided pressure-sensitive adhesive tape was produced in the same manner as in Example 5, except that the (meth)acrylic polymer E was used. This pressure-sensitive adhesive layer had a gel fraction of 12%.

### Comparative Example 5

A double-sided pressure-sensitive adhesive tape was produced in the same manner as in Example 5, except that the (meth)acrylic polymer F was used. This pressure-sensitive adhesive layer had a gel fraction of 32%.

### Comparative Example 6

A double-sided pressure-sensitive adhesive tape was produced in the same manner as in Example 5, except that the (meth)acrylic polymer D was used. This pressure-sensitive adhesive layer had a gel fraction of 40%.

The amounts of the monomers and initiators added in the synthesis of the (meth)acrylic polymers are shown in Table 1. With respect to Examples 1 to 3 and Comparative Examples 1 to 3, the weight average molecular weight of the (meth)acrylic polymer used, and the gel fraction, the maximum stress and the maximum elongation of the pressure-sensitive adhesive layer were evaluated, and the deformation resistance was further evaluated as described below. The results are shown in Table 2. With respect to Examples 4 to 6 and Comparative Examples 4 to 6, the weight average molecular weight of the (meth)acrylic polymer used, and the gel fraction, the storage modulus, the loss modulus and the tan δ of the pressure-sensitive adhesive layer were evaluated, and the deformation resistance was evaluated as described below. The results are shown in Table 3.

### (Method for Evaluating Deformation Resistance)

One side of a glass plate (trade name: MICRO SLIDE GLASS S200423, manufactured by Matsunami Glass Ind. Ltd., having a size of 65 mm×165 mm, and a thickness of 1.2 to 1.5 mm) was laminated with a polarizing plate (polarizing plate manufactured by Nitto Denko Corporation, having a TAC film (trade name: TD80UL, manufactured by FUJIFILM Corporation) on its surface layer) having the same area as that of the glass plate.

Next, the double-sided pressure-sensitive adhesive tapes obtained in Examples and the like were stamped and processed into a shape of picture-frame having an outer circumference of 57 mm×44 mm, an inner circumference of 53 mm×40 mm, and a width of 2 mm.

One side of the double-sided pressure-sensitive adhesive tape stamped and processed into the shape of picture-frame was bonded to the surface of the polarizing plate, and the other pressure-sensitive adhesive side thereof was bonded to a brightness enhancement film (trade name: TBEF-T-1140, manufactured by 3M Company, having a size of 55 mm×42 mm and a thickness of 0.065 mm) to prepare a sample. At this time, a width of the bonded parts of the double-sided pressure-sensitive adhesive tape and the brightness enhancement film was one mm. Two laminates in which the polarizing plate/the double-sided pressure-sensitive adhesive tape in the shape of picture-frame/the brightness enhancement film were laminated in this order on the glass plate were produced as samples.

The samples were kept in heat and cold cycles (one cycle in which the sample was stored at a high temperature of 80° C. for one hour and at a low temperature of −30° C. for one hour was repeated 100 cycles), and then a degree of the deformation was visually evaluated. Evaluation was made that the sample which did not deform was o, and the sample which deformed was x.

TABLE 1

| | | (meth)acrylic polymer | | | | | |
|---|---|---|---|---|---|---|---|
| unit (part) | | A | B | C | D | E | F |
| monomer | 2EHA | 92 | 92 | 86 | 84 | 96 | 88 |
| blended | CHMA | 4 | — | 10 | 4 | — | 8 |
| | MMA | — | 4 | — | — | — | — |
| | AA | 4 | 4 | 4 | 12 | 4 | 4 |

| | | | | | | |
|---|---|---|---|---|---|---|
| initiator (AIBN) | 0.2 | 0.2 | 0.2 | 0.2 | 0.2 | 0.2 |

TABLE 2

| composition and | Examples | | | Comparative Examples | | |
|---|---|---|---|---|---|---|
| property result | 1 | 2 | 3 | 1 | 2 | 3 |
| (meth)acrylic polymer | A | A | B | C | D | E |
| polyfunctional epoxy | 0.015 | 0.02 | 0.02 | 0.02 | 0.02 | 0.02 |
| cross-linking agent | | | | | | |
| (part) | | | | | | |
| isocyanate cross- | 1 | 1 | 1 | 1 | 1 | 1 |
| linking agent (part) | | | | | | |
| weight average | 570,000 | 570,000 | 580,000 | 660,000 | 610,000 | 660,000 |
| molecular weight | | | | | | |
| gel fraction (%) of | 13 | 25 | 23 | 28 | 56 | 18 |
| pressure-sensitive | | | | | | |
| adhesive layer | | | | | | |
| maximum stress (N/mm²) | 1.0 | 1.2 | 1.0 | 1.6 | 1.7 | 0.9 |
| maximum elongation (%) | 1350 | 1100 | 1250 | 800 | 750 | 1850 |
| deformation resistance | ∘ | ∘ | ∘ | x | x | x |

TABLE 3

| composition and | Examples | | | Comparative Examples | | |
|---|---|---|---|---|---|---|
| property result | 4 | 5 | 6 | 4 | 5 | 6 |
| (meth)acrylic polymer | A | A | A | E | F | D |
| polyfunctional epoxy | 0.01 | 0.01 | 0 | 0.01 | 0.01 | 0.01 |
| cross-linking agent | | | | | | |
| (part) | | | | | | |
| isocyanate cross- | 0 | 1 | 0 | 1 | 1 | 1 |
| linking agent (part) | | | | | | |
| weight average | 570,000 | 570,000 | 570,000 | 660,000 | 550,000 | 610,000 |
| molecular weight | | | | | | |
| gel fraction (%) of | 7 | 13 | 0 | 12 | 32 | 40 |
| pressure-sensitive | | | | | | |
| adhesive layer | | | | | | |
| storage modulus (×10⁵ Pa) | 20.1 | 23.9 | 8.1 | 7.8 | 18.4 | 159.0 |
| loss modulus (×10⁵ Pa) | 29.2 | 30.2 | 9.8 | 9.7 | 24.7 | 172.0 |
| tanδ | 0.58 | 0.58 | 0.58 | 0.63 | 0.70 | 0.69 |
| deformation resistance | ∘ | ∘ | ∘ | x | x | x |

As apparent from the results of Table 2, it was confirmed that even if each of the pressure-sensitive adhesive tapes in Examples 1 to 3, in which the pressure-sensitive adhesive layers are formed from the specific amounts of the specific monomers, and the gel fractions thereof are controlled to the specific range, is exposed to severe environmental changes, being the heat and cold cycles (total 100 cycles) of not only high temperatures (80° C.) but also low temperatures (−30° C.), the deformation of the adherend (brightness enhancement film) is inhibited. It was also confirmed that when the pressure-sensitive adhesive layers have the desired maximum stress and the desired maximum elongation, the deformation of the adherend (brightness enhancement film) can be inhibited.

In Comparative Example 1 in which the amount of the ethylenically unsaturated monomer contained was over the defined range, contrary to Examples 1 to 3, the maximum elongation could not reach the desired range, thus resulting in poor deformation resistance. In Comparative Example 2 in which the amount of the carboxyl group-containing monomer contained was over the defined range, the gel fraction remarkably exceeded the desired range, as a result, all of the properties were inferior to those obtained in Examples. In Comparative Example 3 in which the ethylenically unsaturated monomer was not used, the maximum elongation was over the desired range, thus resulting in poor deformation resistance.

As apparent from the results in Table 3, it was confirmed that even if each of the pressure-sensitive adhesive tapes in Examples 4 to 6 having the desired storage modulus, loss modulus and tan δ is exposed to severe environmental changes, being the heat and cold cycles (total 100 cycles) of not only high temperatures (80° C.) but also low temperatures (−30° C.), the deformation of the adherend (brightness enhancement film) is inhibited.

In Comparative Example 4 wherein the pressure-sensitive adhesive layer had the storage modulus smaller than the desired range, or in Comparative Examples 5 and 6 in which the tan δ was higher than the desired range, contrary to Examples 4 to 6, the results of poor deformation resistance were obtained.

1. A pressure-sensitive adhesive tape having a pressure-sensitive adhesive layer comprising a pressure-sensitive adhesive composition containing a (meth)acrylic polymer, wherein
the (meth)acrylic polymer is obtained by copolymerization of a monomer mixture including, at least, 60 to 96% by weight of a (meth)acrylic acid alkyl ester having an alkyl group with 4 to 12 carbon atoms,
2 to 10% by weight of a carboxyl group-containing monomer, and
2 to 8% by weight of an ethylenically unsaturated monomer having no carboxyl group, whose homopolymer has a glass transition temperature of 50 to 190° C., and
the pressure-sensitive adhesive layer has a gel fraction of 0 to 30% by weight.

2. The pressure-sensitive adhesive tape according to claim 1, wherein the pressure-sensitive adhesive layer has a maximum stress of 0.8 to 1.6 N/mm² and a maximum elongation of 1000 to 1700% in the stress-strain curve at 0° C.

3. A pressure-sensitive adhesive tape having a pressure-sensitive adhesive layer comprising a pressure-sensitive adhesive composition containing a (meth)acrylic polymer obtained by polymerizing at least a (meth)acrylic acid alkyl ester having an alkyl group with 4 to 12 carbon atoms, wherein
the pressure-sensitive adhesive layer has a storage modulus of 8.0×10⁵ to 1.5×10⁷ Pa at −30° C., a loss modulus of 9.7×10⁵ to 1.7×10⁷ Pa at −30° C., and a tan δ of 0.50 to 0.63 at 80° C.

4. The pressure-sensitive adhesive tape according to claim 3, wherein the (meth)acrylic polymer obtained by copolymerization of a monomer mixture containing, at least, 60 to 96% by weight of the (meth)acrylic acid alkyl ester having an alkyl group with 4 to 12 carbon atoms, and further containing 2 to 10% by weight of a carboxyl group-containing monomer, and 2 to 8% by weight of an ethylenically unsaturated monomer having no carboxyl group, whose homopolymer has a glass transition temperature of 50 to 190° C., as monomer components, and
the pressure-sensitive adhesive layer has a gel fraction of 0 to 30% by weight.

5. The pressure-sensitive adhesive tape according to claim 1, wherein the ethylenically unsaturated monomer is cyclohexyl methacrylate.

6. A pressure-sensitive adhesive tape having a pressure-sensitive adhesive layer comprising a pressure-sensitive adhesive composition containing a (meth)acrylic polymer obtained by polymerizing at least a (meth)acrylic acid alkyl ester having an alkyl group with 4 to 12 carbon atoms, wherein
the pressure-sensitive adhesive layer has a maximum stress of 0.8 to 1.6 N/mm² and a maximum elongation of 1000 to 1700% in the stress-strain curve at 0° C.

7. The pressure-sensitive adhesive tape according to claim 1, wherein the pressure-sensitive adhesive layer is formed on at least one side of a substrate.

8. The pressure-sensitive adhesive tape according to claim 1, wherein the pressure-sensitive adhesive layer has a thickness of 2 to 20 μM.

9. The pressure-sensitive adhesive tape according to claim 1, which is used for fixing a part of a portable electronic instrument.

10. The pressure-sensitive adhesive tape according to claim 2, wherein the ethylenically unsaturated monomer is cyclohexyl methacrylate.

11. The pressure-sensitive adhesive tape according to claim 4, wherein the ethylenically unsaturated monomer is cyclohexyl methacrylate.

12. The pressure-sensitive adhesive tape according to claim 3, wherein the pressure-sensitive adhesive layer is formed on at least one side of a substrate.

13. The pressure-sensitive adhesive tape according to claim 6, wherein the pressure-sensitive adhesive layer is formed on at least one side of a substrate.

14. The pressure-sensitive adhesive tape according to claim 3, wherein the pressure-sensitive adhesive layer has a thickness of 2 to 20 μM.

15. The pressure-sensitive adhesive tape according to claim 6, wherein the pressure-sensitive adhesive layer has a thickness of 2 to 20 μM.

16. The pressure-sensitive adhesive tape according to claim 3, which is used for fixing a part of a portable electronic instrument.

17. The pressure-sensitive adhesive tape according to claim 6, which is used for fixing a part of a portable electronic instrument.

18. The pressure-sensitive adhesive tape according to claim 1, wherein the (meth)acrylic polymer has a molecular weight of 200,000 to 1,000,000.
